(19) United States
(12) Patent Application Publication
(10) Pub. No.: US 2014/0285445 A1
(43) Pub. Date: Sep. 25, 2014

(54) PORTABLE DEVICE AND OPERATING METHOD THEREOF

(71) Applicant: WISTRON CORPORATION, New Taipei City (TW)

(72) Inventors: Yao-Tsung Chang, New Taipei City (TW); Chia-Hsien Li, New Taipei City (TW); Hong-Chi Chen, New Taipei City (TW); Pai-Yang Lin, New Taipei City (TW)

(73) Assignee: Wistron Corporation, New Taipei City (TW)

(21) Appl. No.: 13/868,120

(22) Filed: Apr. 23, 2013

(30) Foreign Application Priority Data
Mar. 25, 2013 (TW) 102110525

(51) Int. Cl. G06F 3/041

(52) U.S. Cl. CPC G06F 3/0412
USPC 345/173

(57) ABSTRACT

An operating method for a portable device is provided, wherein the portable device has a touch sensing unit and a display unit coupled to the touch sensing unit. The display unit displays an icon menu comprising a plurality of icons. In the operating method, the touch sensing unit senses a touch action to generate a sensing signal. The sensing signal is analyzed to determine whether the touch action is a holding action. When the touch action is determined to be the holding action, a mis-touch recovering operation is performed on the icon corresponding to a contact region touched by the touch action. When it is determined that the touch action is not the holding action, a function corresponding to the icon corresponding to a contact region touched by the touch action is executed.

### CROSS-REFERENCE TO RELATED APPLICATION

This application claims the priority benefit of Taiwan application serial no. 102110525, filed on Mar. 25, 2013. The entirety of the above-mentioned patent application is hereby incorporated by reference herein and made a part of this specification.

### BACKGROUND OF THE INVENTION

1. Field of Invention

The present invention relates to a portable device and an operating method thereof. More particularly, the present invention relates to a portable device and an operating method of the portable device which can prevent the mis-touch due to the user holding the portable device.

2. Description of Related Art

To cope with modern busy lifestyle, various portable electronic devices with less space occupation are continually developed. Taking a handheld communication device such as a personal digital assistant (PDA) mobile phone or a smart phone as an example, besides possessing various functions of a conventional communication device, the handheld communication device further allows the user to utilize the built-in window system to edit documents, to receive or send emails, to browse websites or to use the instant massaging application. Namely, such handheld communication device is not only used for making phone calls, but is also used to provide diversified functions as that does of a small personal computer. With development of wireless network technology, utilization of these functions is no longer limited by space and time, which is convenient for those modern people constantly pursuing efficiency.

With quick development of a pointing stick and touch pad technique, manufacturers of electronic products such as notebook computers, mobile phones or portable multimedia players, etc. generally use a touch screen to replace a conventional keyboard to server as a new generation of input interface. Taking the mobile phone as an example, when a user operates the conventional mobile phone, the user has to click the keyboard with fingers while referring to an image displayed on a screen, so as to input characters or select menus, etc. However, to operate a mobile phone integrating a touch screen, besides the fingers, the user may also use an auxiliary device such as a stylus to directly input characters on the screen or open application programs. Therefore, the touch screen provides the user a flexible and convenient input manner.

When the touch screen is at an unlocked status and the user holds the portable device having the touch screen by hands, it is inevitable to touch the touch screen by user's hand. Thus, the specific functions (such as making phone calls) is unexpectedly executed, needless data is downloaded or the unexpected operation is launched, which lead to problems for the user in using the portable device.

### SUMMARY OF THE INVENTION

The present invention is to provide an operation method and a portable device executing the operating method which are capable of preventing the problems of unexpectedly executing the functions corresponding to the icons which is mis-touched by the hand while the user holds the portable device.

The invention provides an operating method for a portable device. The portable device has a touch sensing unit and a display unit coupled to the touch sensing unit, and the display unit displays an icon menu including a plurality of icons. The method comprises sensing a touch action by the touch sensing unit to generate a sensing signal and analyzing the sensing signal to determine whether the touch action is a holding action. A mis-touch recovering operation is performed on at least one of the icons corresponding to a contact region touched by the touch action when the touch action is determined to be the holding action. A function corresponding to the at least one of the icons corresponding to the contact region touched by the touch action is executed when the touch action is determined not the holding action.

According to the one embodiment of the present invention, the step of analyzing the sensing signal to determine whether the touch action is a holding action further comprises: determining the touch action is the holding action when an area variation of the contact region is smaller than a predetermined variation within a predetermined time interval.

According to the one embodiment of the present invention, the predetermined variation is about 20%.

According to the one embodiment of the present invention, the step of analyzing the sensing signal to determine whether the touch action is a holding action further comprises: determining the touch action is the holding action when the contact region includes an edge of the touch sensing unit or a peripheral region of the touch sensing unit.

According to the one embodiment of the present invention, the peripheral region of the touch sensing unit includes an even-width region which is extended from the edge of the touch sensing unit toward an interior region of the touch sensing unit for a width of about at least one centimeter.

According to the one embodiment of the present invention, the step of analyzing the sensing signal to determine whether the touch action is a holding action further comprises: determining the touch action is the holding action when a contact area of the contact region is larger than a predetermined area.

According to the one embodiment of the present invention, the step of analyzing the sensing signal to determine whether the touch action is a holding action further comprises: determining the touch action is the holding action when a contact pressure of the touch action on the touch sensing unit is smaller than a predetermined pressure.

According to the one embodiment of the present invention, the mis-touch recovering operation comprises: ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region.

The present invention provides a portable device. The portable device comprises a touch sensing unit, a display unit and a processor. The touch sensing unit senses a touch action to generate a sensing signal. The display unit is coupled to the touch sensing unit, wherein the display unit displays an icon menu including a plurality of icons. The processor analyzes the sensing signal to determine whether the touch action is a holding action. A mis-touch recovering operation is performed by the processor on at least one of the icons corresponding to a contact region touched by the touch action when the touch action is determined to be the holding action. A function corresponding to the at least one of the icons corresponding to the contact region touched by the touch action is executed by the processor when the touch action is determined not the holding action.

According to one embodiment of the present invention, the processor analyzing the sensing signal to determine whether the touch action is the holding action further comprises: determining the touch action is the holding action by the processor when an area variation of the contact region is smaller than a predetermined variation within a predetermined time interval.

According to one embodiment of the present invention, the predetermined variation is about 20%.

According to one embodiment of the present invention, the processor analyzing the sensing signal to determine whether the touch action is the holding action further comprises: determining the touch action is the holding action by the processor when the contact region includes an edge of the touch sensing unit or a peripheral region of the touch sensing unit.

According to one embodiment of the present invention, the peripheral region of the touch sensing unit includes an even-width region which is extended from the edge of the touch sensing unit toward an interior region of the touch sensing unit for a width of about at least one centimeter.

According to one embodiment of the present invention, the processor analyzing the sensing signal to determine whether the touch action is a holding action further comprises: determining the touch action is the holding action by the processor when a contact area of the contact region is larger than a predetermined area.

According to one embodiment of the present invention, the processor analyzing the sensing signal to determine whether the touch action is a holding action further comprises: determining the touch action is the holding action by the processor when a contact pressure of the touch action on the touch sensing unit is smaller than a predetermined pressure.

According to one embodiment of the present invention, the mis-touch recovering operation performed by the processor comprises: ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region.

Accordingly, the sensing value in the sensing signal corresponding to the touch action is analyzed to determine whether the touch action is the holding action. When the touch action is determined to be the holding action, the mis-touch recovering operation is performed. The mis-touch recovering operation includes ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region. Therefore, the possibility of the user holding the portable device to trigger the portable device to generate the sensing signal so as to lead to launching unexpected function can be decreased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a process flow chart schematically illustrating an operation method of a portable device according to one embodiment of the invention.

FIG. 2 is a schematic diagram showing a portable device according to one embodiment of the present invention.

FIG. 3 is a schematic diagram showing a display unit of a portable device displaying an icon menu.

FIG. 4 is a schematic diagram showing the edge of a touch unit of a portable device.

FIG. 5 is a schematic diagram showing the peripheral region of a touch unit of a portable device.

FIG. 6A through FIG. 6F are schematic diagrams respectively showing an icon menu displayed by the display unit after a mis-touch recovering operation is performed by the processor.

### DESCRIPTION OF THE PREFERRED EMBODIMENTS

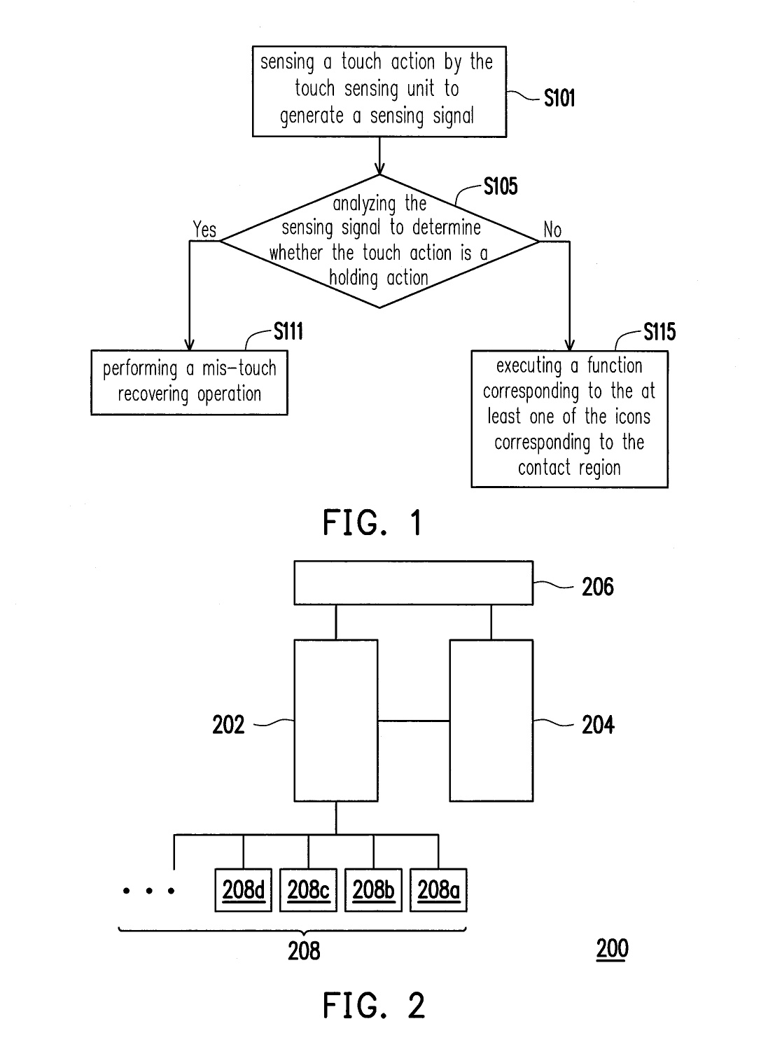

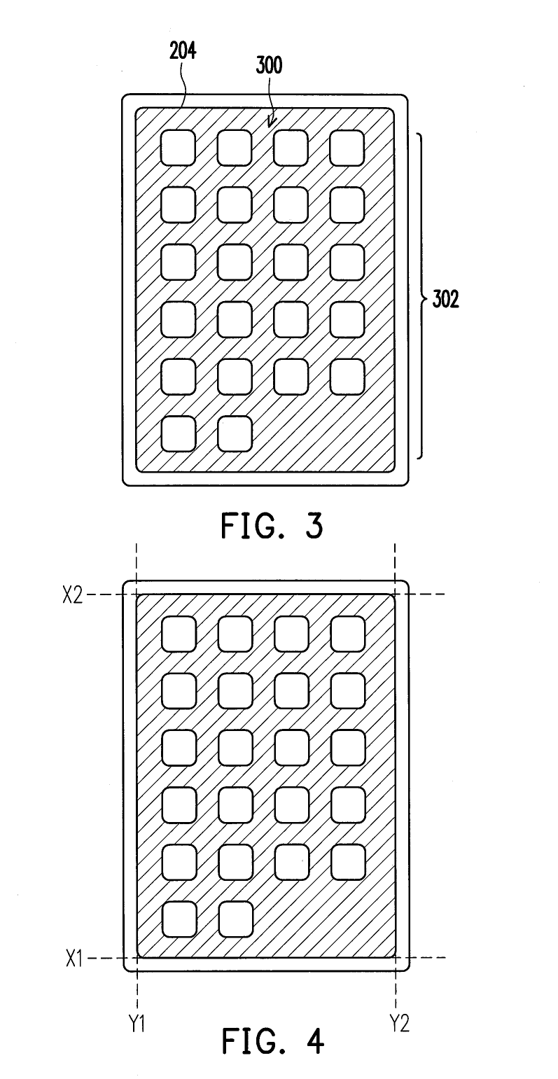

FIG. 1 is a process flow chart schematically illustrating an operation method of a portable device according to one embodiment of the invention. FIG. 2 is a schematic diagram showing a portable device according to one embodiment of the present invention. As shown in FIG. 1 and FIG. 2, the operating method of the portable device of the present embodiment is suitable for a portable device 200. The portable device 200 has a touch sensing unit 202, a display unit 204 coupled to the touch sensing unit 202 and a processor 206. The portable device 200 can be, for example but not limited to, a mobile phone, a personal digital assistant, a tablet personal computer, a smart phone or any electronic device having a touch-sensing display which is integrated by a touch sensing unit and a display unit. The touch sensing unit 202 is coupled to at least one sensing unit 208, such as a contact area sensor 208a, a contact pressure sensor 208b, a contact time sensor 208c or an infrared sensor 208d, so that various values corresponding to the touch action of the user touching the touch sensing unit can be sensed. The values comprise the contact area of the touch action sensed by the contact area sensor 208a, the contact pressure of the touch action sensed by the contact pressure sensor 208b, the contact time sensed by the contact time sensor 208c or the contact behavior sensed by the infrared sensor 208d. The aforementioned connect behavior can be, for example, the moving trace of the touch action which changes with time.

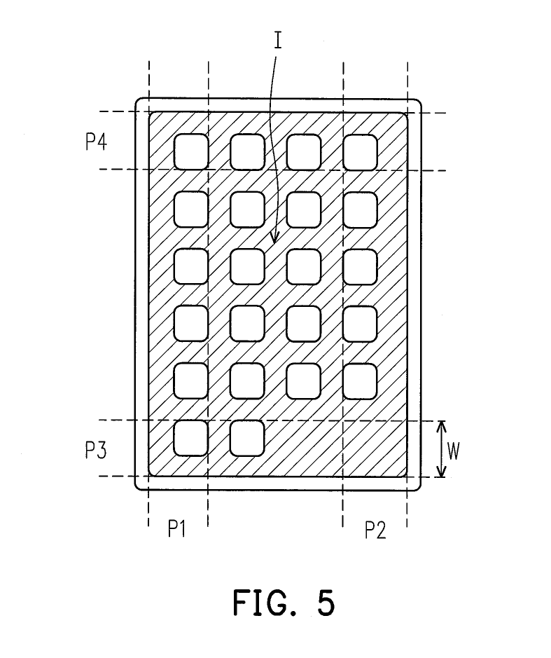

FIG. 3 is a schematic diagram showing a display unit of a portable device displaying an icon menu. As shown in FIG. 3, the display unit 204 displays an icon menu 300 having a plurality of icons 302. As shown in FIG. 1, FIG. 2 and FIG. 3, in the step S101 of the operating method of the portable device of the present embodiment, the touch sensing unit 202 senses a touch action of the user on the touch sensing unit 202 so as to generate a sensing signal. The sensing signal, can be, for example, composed of the values (as mentioned above) corresponding to the touch action generated by the touch sensing unit sensing the touch action. More clearly, the sensing signal can include, for example, the contact position of the contact region on the touch sensing unit touched by the touch action, the contact area of the connect region, the contact pressure of the touch action, the contact time or the contact behavior.

In the step S105, the processor 206 analyzes the sensing signal to determine whether the touch action is a holding action. In the step S111, when the touch action is determined to be the holding action, a mis-touch recovering operation is performed by the processor 206 on at least one of the icons corresponding to the connect region of the touch sensing unit touched by the touch action. Alternatively, in the step S115, when touch action is determined not the holding action, a function corresponding to at least one of the icons corresponding to the contact region is executed by the processor 206. More clearly, the processor 206 further analyzes the sensing signal to determined that the touch action is an effective touch action but not a holding action so that the processor 206 executes the function represented by one of the icons corresponding to the contact region. The aforementioned effective touch action is the action intentionally made by the user to choose the icon 302 in the icon menu 300 so as to intentionally launch the function corresponding to the icon 302.

In one embodiment, in the aforementioned step S105, the processor 206 analyzing the sensing signal to determine whether the touch action is the holding action further comprises, for example, determining the touch action is the holding action by the processor 206 when an area variation of the contact region is smaller than a predetermined variation within a predetermined time interval. More clearly, the processor 206 analyzes the sensing signal to obtain the contact time which the touch action touches the touch sensing unit 202 for. When the contact time is larger than a predetermined time interval and, within the predetermined time interval, the area variation of the contact region is smaller than a predetermined variation, the touch action is determined to be the holding action. For instance, when the time the touch action touches the touch sensing unit 202 for is larger than one second (that is, the predetermined time interval is at least one second) and the area variation of the contact region during the one second interval is smaller than 20% (That is, the predetermined variation is about 20%), the processor 206 determines that the touch action is the holding action.

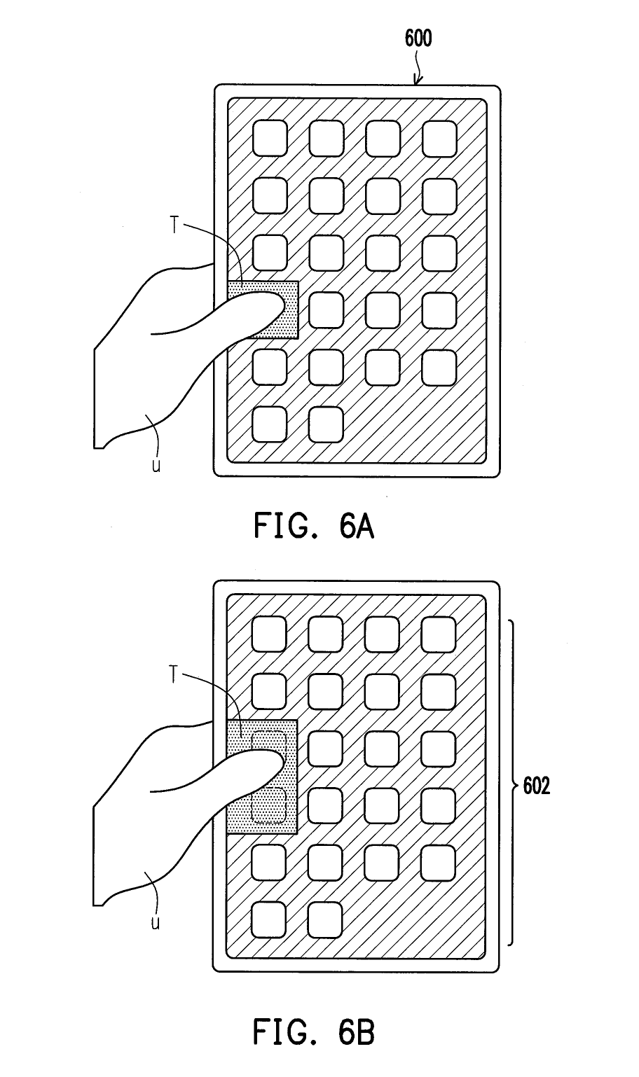

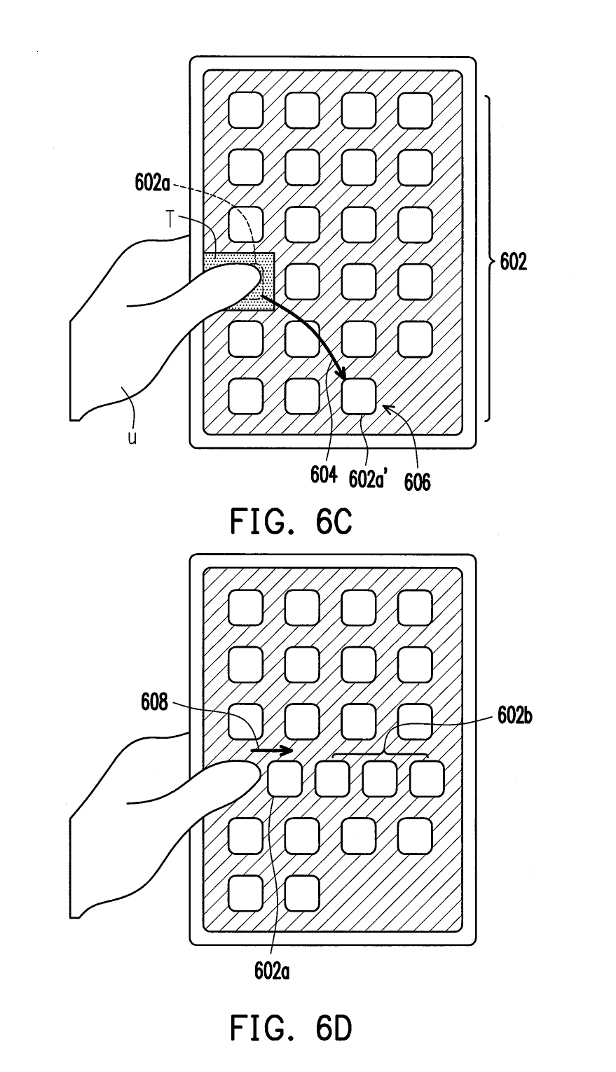

In another embodiment, in the aforementioned step S105, the processor 206 analyzing the sensing signal to determine whether the touch action is the holding action further comprises, for example, analyzing the sensing signal by the processor 206 to obtain a range of the contact region. When the range of the contact region includes an edge of the touch sensing unit 202 (such as one of the edges X1, X2, Y1 and Y2 shown in FIG. 4) or a peripheral region of the touch sensing unit 202 (such as one of the peripheral regions P1, P2, P3 and P4 shown in FIG. 5), the touch action is determined to be the holding action. For instance, the peripheral region (such as the peripheral regions P1, P2, P3 and P4 shown in FIG. 5) includes an even-width region (such as the continuous band-type regions P1, P2, P3 and P4 shown in FIG. 5) which is extended from the edge (such as the edges X1, X2, Y1 and Y2 shown in FIG. 4) of the touch sensing unit 202 toward an interior region I of the touch sensing unit 202 for a width W (the width is at least one centimeter, for example).

In the other embodiment, in the aforementioned step S105, the processor 206 analyzing the sensing signal to determine whether the touch action is the holding action further comprises, for example, analyzing the sensing signal by the processor 206 to obtain a contact area of the contact region. When the contact area is larger than a predetermined area, the touch action is determined to the holding action. The aforementioned predetermined area is set, for example, according to the contact area of the effective touch action of the user analyzed by the processor. In one embodiment, the predetermined area can be a default setting value defined by the manufacture of the portable device according to the general usage habit. In another embodiment, the predetermined area can be about 1.5 cm².

In the other embodiment, in the aforementioned step S105, the processor 206 analyzing the sensing signal to determine whether the touch action is the holding action further comprises, for example, analyzing the sensing signal by the processor 206 to obtain a ratio of the major axis of the contact region to the minor axis of the contact region. When the ratio of the major axis of the contact region to the minor axis of the contact region is larger than or equal to a predetermined ratio, the touch action is determined to be the holding action. The aforementioned predetermined ratio of the major axis of the contact region to the minor axis of the contact region can be, for example, 2. More clearly, at the time the user made the touch action to control the touch sensing unit 202, the user usually uses index finger or middle finger. Even in a multi-touch operation, only thumb will be used in the multi-touch operation. Hence, at the time the fingers or the stylus touch the touch sensing unit to control the touch sensing unit, the shape of the contact region approximates a circle with a diameter of about 0.8 cm and the ratio of the major axis of the contact region to the minor axis of the contact region is about 1˜1.5. However, when the user holds the portable device, most of the user uses thumb or a portion of the palm of the hand near the thumb to hold/touch the touch sensing unit 202. Thus, the shape of the contact region of the holding action approximates an ellipse having an obvious major axis and an obvious minor axis and the length of the major axis is larger than or equal to 1.5 cm. Therefore, the ratio of the major axis of the contact region to the minor axis of the contact region can be, for example, larger than or equal to 2.

In the other embodiment, in the aforementioned step S105, the processor 206 analyzing the sensing signal to determine whether the touch action is the holding action further comprises, for example, analyzing the sensing signal by the processor 206 to obtain a contact pressure of the touch action on the touch sensing unit 202. When the contact pressure is smaller than a predetermined pressure, the touch action is determined to be the holding action. The aforementioned predetermined pressure is set, for example, according to the contact pressure of the effective touch action of the user analyzed by the processor. In one embodiment, the predetermined pressure can be a default setting value defined by the manufacture of the portable device according to the general usage habit. In another embodiment, the predetermined pressure can be about 40 g/cm².

In the aforementioned embodiments, whether the touch action is the holding action is determined according to a single sensing value (the contact area of the touch action, the contact pressure of the touch action, the contact time of the touch action, the ratio of the major axis to the minor axis of the contact region and the contact behavior) corresponding to the touch action and included in the sensing signal. However, the present invention is not limited thereto. The processor 206 can determine whether the touch action is the holding action according to the combination of at least two of the sensing value (that is any combination of at least two of the contact area of the touch action, the contact pressure of the touch action, the contact time of the touch action, the ratio of the major axis to the minor axis of the contact region and the contact behavior). More clearly, in one embodiment, the processor 206 analyzes the sensing signal and determines the touch action is the holding action when the contact region of the touch sensing unit 202 which the touch action touches includes the edge of the touch sensing unit 202 (at least one of the edges X1, X2, Y1 and Y2 shown in FIG. 4) and the contact time is larger then the predetermined time interval (as described in the previous embodiment). In another embodiment, the processor 206 analyzes the sensing signal and determines the touch action is the holding action when the contact region of the touch sensing unit 202 which the touch action touches includes the peripheral region of the touch sensing unit 202 (at least one of the peripheral regions P1, P2, P3 and P4 shown in FIG. 5) and the contact time is larger then the predetermined time interval (as described in the previous embodiment).

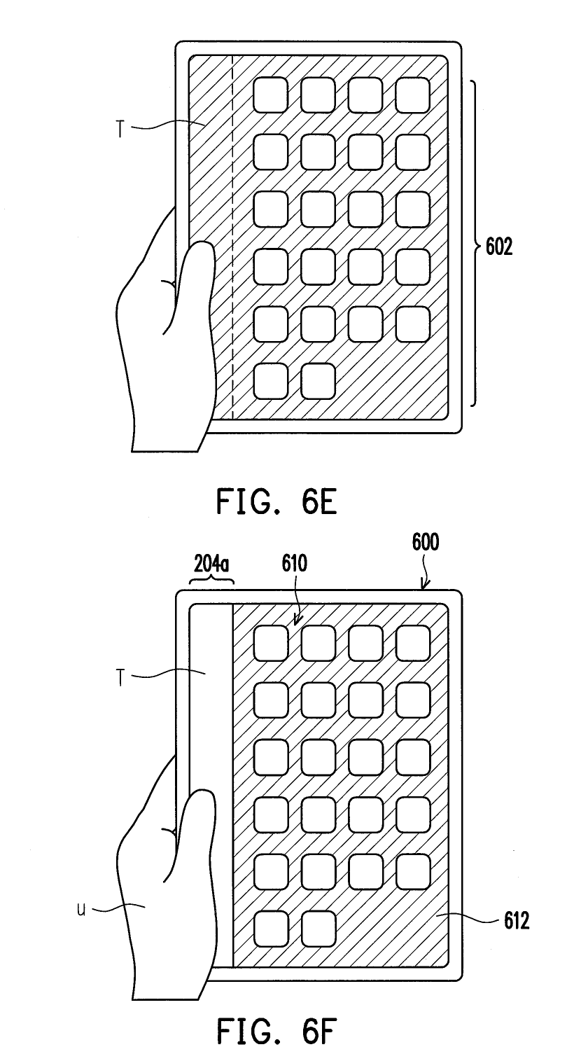

In the following paragraphs, several embodiments are described accompanied with drawings to detail various mis-touch recovery operations after the touch action is determined to be the holding action. FIG. 6A through FIG. 6F are schematic diagrams respectively showing an icon menu displayed by the display unit after a mis-touch recovering operation is performed by the processor. As shown in FIG. 6A, in the aforementioned step S111, when the touch action is determined to be the holding action, the mis-touch recovering operation performed by the processor 206 comprises, for example, ignoring the touch action. That is, the sensing signal generated according to the touch action is ignored. That is, in the user's point of view, the contact region T of the touch sensing unit 202 which is touched by the user's finger U while the user holds the portable device 600 with the finger U is partially locked so that the processor 206 does not response the touch action of the finger U on the contact region T.

In another embodiment, as shown in FIG. 6B, in the aforementioned step S111, when the touch action is determined to be the holding action, the mis-touch recovering operation performed by the processor 206 comprises, for example, rearranging all of the icons 602 so that the rearranged icons 602 dodge the contact region T and do not overlap the contact region T.

In the other embodiment, in the aforementioned step S111, when the touch action is determined to be the holding action, the mis-touch recovering operation performed by the processor 206 comprises, for example, moving the icons corresponding to the contact region T so that the moved icons is far away from the contact region T. For instance, as shown in FIG. 6C, the mis-touch recovering operation performed by the processor 206 is to move the icon 602a corresponding to the contact region T to the position 606 (the moving path is denoted by number 604 shown in FIG. 6C) and the moved icon is re-labeled 602a′ which is far away from the contact region T. In the other embodiment, the mis-touch recovering operation performed by the processor 206 is to move the icon 602a corresponding to the contact region T and to move the icons 602b near the icon 602a (such as the icon 602a and the icons 602b which is arranged at the same row of the icon 602a shown in FIG. 6D) to the position (the moving path is denoted by number 608 shown in FIG. 6D) in which the moved icons 602a and 602b are far away from the contact region T and do not overlap the contact region T.

In the other embodiment, as shown in FIG. 6E, the mis-touch recovering operation performed by the processor 206 comprises, for example, shifting all of the icons 602 so that the shifted icons 602 do not overlap the contact region T. In the other embodiment, as shown in FIG. 6F, the mis-touch recovering operation performed by the processor 206 comprises, for example, panning the icon menu 610 so that the panned icon menu 610 does not overlap the contact region T. More clearly, the icon menu comprises the background picture 612 and all of the icons 602. Thus, in this embodiment, the icon menu 610 panned to be far away from the contact region T and the panned icon menu 610 not overlapping the contact region T mean that the background picture 312 and all of the icons 602 are panned at the same time so that the panned background picture 612 and the panned icons 602 are far away from the contact region T and do not overlap the contact region T. In other words, in the user's point of view, the display frame 204a of the display unit 204 is enlarged by the boundary of the display frame moving toward the interior region I of the touch sensing unit 202/display unit 204 according to the position of the contact region T of the touch sensing unit 202 touched by the user's finger U while the user holds the portable device 600.

Altogether, various sensing values in the sensing signal corresponding to the touch action are analyzed to determine whether the touch action is the holding action. When the touch action is determined to be the holding action, the mis-touch recovering operation is performed. The mis-touch recovering operation includes ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region. Therefore, the possibility of the user holding the portable device to trigger the portable device to generate the sensing signal so as to lead to launching unexpected function can be decreased.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An operating method for a portable device, wherein the portable device has a touch sensing unit and a display unit coupled to the touch sensing unit, and the display unit displays an icon menu including a plurality of icons, the method comprising:
sensing a touch action by the touch sensing unit to generate a sensing signal;
analyzing the sensing signal to determine whether the touch action is a holding action;
performing a mis-touch recovering operation on at least one of the icons corresponding to a contact region touched by the touch action when the touch action is determined to be the holding action; and
executing a function corresponding to the at least one of the icons corresponding to the contact region touched by the touch action when the touch action is determined not the holding action.

2. The operating method of claim 1, wherein the step of analyzing the sensing signal to determine whether the touch action is a holding action further comprises:
determining the touch action is the holding action when an area variation of the contact region is smaller than a predetermined variation within a predetermined time interval.

3. The operating method of claim 2, wherein the predetermined variation is about 20%.

4. The operating method of claim 1, wherein the step of analyzing the sensing signal to determine whether the touch action is a holding action further comprises:
determining the touch action is the holding action when the contact region includes an edge of the touch sensing unit or a peripheral region of the touch sensing unit.

5. The operating method of claim 4, wherein the step of determining the touch action is the holding action is further based on a scenario selected from a group comprising of that an area variation of the contact region is smaller than 20%, a contact area of the contact region is larger than 1.5 cm², a ratio of a major axis of the contact region to a minor axis of the contact region is larger than or equal to 2, a contact pressure of the touch action on the touch sensing unit is smaller than 40 g/cm² and the combination thereof.

6. The operating method of claim 4, wherein the peripheral region of the touch sensing unit includes an even-width region which is extended from the edge of the touch sensing unit toward an interior region of the touch sensing unit for a width of about at least one centimeter.

7. The operating method of claim 1, wherein the step of analyzing the sensing signal to determine whether the touch action is a holding action further comprises:
determining the touch action is the holding action when a contact area of the contact region is larger than a predetermined area.

8. The operating method of claim 1, wherein the step of analyzing the sensing signal to determine whether the touch action is a holding action further comprises:
determining the touch action is the holding action when a contact pressure of the touch action on the touch sensing unit is smaller than a predetermined pressure.

9. The operating method of claim 1, wherein the mis-touch recovering operation comprises: ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region.

10. A portable device, comprising:
a touch sensing unit, sensing a touch action to generate a sensing signal;
a display unit, coupled to the touch sensing unit, wherein the display unit displays an icon menu including a plurality of icons;
a processor, analyzing the sensing signal to determine whether the touch action is a holding action, wherein a mis-touch recovering operation is performed by the processor on at least one of the icons corresponding to a contact region touched by the touch action when the touch action is determined to be the holding action and a function corresponding to the at least one of the icons corresponding to the contact region touched by the touch action is executed by the processor when the touch action is determined not the holding action.

11. The portable device of claim 10, wherein the processor analyzing the sensing signal to determined whether the touch action is the holding action further comprises:
determining the touch action is the holding action by the processor when an area variation of the contact region is smaller than a predetermined variation within a predetermined time interval.

12. The portable device of claim 11, wherein the predetermined variation is about 20%.

13. The portable device of claim 10, wherein the processor analyzing the sensing signal to determine whether the touch action is the holding action further comprises:
determining the touch action is the holding action by the processor when the contact region includes an edge of the touch sensing unit or a peripheral region of the touch sensing unit.

14. The portable device of claim 13, wherein the processor determining the touch action is the holding action is further based on a scenario selected from a group comprising of that an area variation of the contact region is smaller than 20%, a contact area of the contact region is larger than 1.5 cm², a ratio of a major axis of the contact region to a minor axis of the contact region is larger than or equal to 2, a contact pressure of the touch action on the touch sensing unit is smaller than 40 g/cm² and the combination thereof.

15. The portable device of claim 13, wherein the peripheral region of the touch sensing unit includes an even-width region which is extended from the edge of the touch sensing unit toward an interior region of the touch sensing unit for a width of about at least one centimeter.

16. The portable device of claim 10, wherein the processor analyzing the sensing signal to determine whether the touch action is a holding action further comprises:
determining the touch action is the holding action by the processor when a contact area of the contact region is larger than a predetermined area.

17. The portable device of claim 10, wherein the processor analyzing the sensing signal to determine whether the touch action is a holding action further comprises:
determining the touch action is the holding action by the processor when a contact pressure of the touch action on the touch sensing unit is smaller than a predetermined pressure.

18. The portable device of claim 10, wherein the mis-touch recovering operation performed by the processor comprises: ignoring the touch action, rearranging the icons so that the rearranged icons do not overlap the contact region, moving the icon corresponding to the contact region so that the moved icon is far away from the contact region, shifting all of the icons so that the shifted icons do not overlap the contact region or panning the icon menu so that the panned icon menu does not overlap the contact region.
